(19) United States
(12) Patent Application Publication
(10) Pub. No.: US 2025/0278060 A1
(43) Pub. Date: Sep. 4, 2025

(54) DEVICE FOR TESTING A WATCH MEMBER

(71) Applicant: Rolex SA, Genève 26 (CH)

(72) Inventors: Mathieu BOTTIN, La Roche-sur-Foron (FR); Romain VERRIER, Coppet (CH)

(21) Appl. No.: 19/061,954

(22) Filed: Feb. 24, 2025

(30) Foreign Application Priority Data
Mar. 1, 2024 (EP) 24160985.8

(51) Int. Cl. G04D 7/00; G04D 1/06

(52) U.S. Cl. CPC G04D 7/008; G04D 1/06

(57) ABSTRACT

Device for testing a watch member, comprising at least:
a holding device, arranged to receive and hold in place the watch member,
a fixing device, arranged to fix the holding device on a testing machine, characterized in that one of the holding device and of the fixing device comprises a counter-shape at least partially matching the other of the holding device and of the fixing device, and in that the counter-shape is arranged to allow an adjustment to fix the holding device according to at least seven distinct relative orientations between the holding device and the fixing device.

### CROSS-REFERENCE TO RELATED APPLICATIONS

The present application claims priority to European Application No. 24160985.8 filed with the European Patent Office on Mar. 1, 2024, which is incorporated herein by reference in their entirety for all purposes.

### TECHNICAL FIELD OF THE INVENTION

The present invention generally concerns a device for testing a watch member and, particularly, the present invention relates to a testing device provided to hold in place a watch member such as for example a movement or a watch case comprising a movement, in order to subject it to dynamic tests such as shocks, vibration tests, or even acceleration tests.

### STATE OF THE ART

In the prior art of the devices for testing watch members, documents CH699300A1 and CH699301A1 are known which describe testing devices provided to hold in place a watch member during mechanical and environmental tests. On the other hand, these devices do not provide great flexibility in the relative positioning between the watch member and the testing machine, since only a few predetermined relative positions are possible. Also, it may be noted that these documents do not propose a solution for easily handling and installing the testing devices described on the testing machine.

### DISCLOSURE OF THE INVENTION

One aim of the present invention is to address the drawbacks of the prior art mentioned above and particularly, first of all, to propose a testing device that provides great ease of use and/or great freedom of relative positioning between the watch member to be tested and the testing machine.

For this, a first aspect of the invention concerns a device for testing a watch member, comprising at least:
a holding device, arranged to receive and hold in place the watch member,
a fixing device, arranged to fix the holding device on a testing machine, characterized in that one of the holding device and of the fixing device comprises a counter-shape (or a counter-form) at least partially matching the other of the holding device and of the fixing device, and in that the counter-shape is arranged to allow an adjustment to fix the holding device according to at least seven distinct relative orientations between the holding device and the fixing device.

The testing device according to the implementation above comprises a holding device that can be repositioned relative to the fixing device (and therefore relative to the testing machine) according to at least seven distinct relative orientations, which makes it possible to test the member according to multiple orientations. For this purpose, one of the holding device and of the fixing device comprises a counter-shape at least partially matching the other of the holding device and of the fixing device. In other words, one of the holding device and of the fixing device comprises a predetermined shape and the other of the holding device and of the fixing device comprises a counter-shape matching the predetermined shape and allowing easy repositioning according to multiple relative positions (at least seven).

In other words, the current watch tests are limited to the six watch positions, which are very specific. The six orientations are orthogonal to each other, with the normal to the plane of the movement parallel or perpendicular to gravity, and the 12 o'clock-6 o'clock axis of the movement parallel or perpendicular to gravity in a vertical position. According to the invention, at least seven relative positions are allowed, and it may be noted that it is at least seven orientations that are not necessarily orthogonal to each other. There is therefore much greater freedom of adjustments in relative positions to increase the representativeness of the constraints undergone by the watch. Even if the six standard watch positions are a theoretical reference that can be used with the present invention, the device for testing a watch member according to the implementation described above makes it possible to test the watch member according to an infinite number of relative arrangements or orientations.

According to one embodiment, the counter-shape comprises at least one continuous portion of contact between the holding device and the fixing device and arranged to allow a continuous variation of the fixing adjustment between at least two distinct and orthogonal relative orientations between the holding device and the fixing device. Such a continuous variation of the fixing adjustment provides an infinite number of relative positions between the holding device and the fixing device, which are as many possibilities for testing the watch member.

According to one embodiment, said at least one continuous portion comprises a continuous surface of contact between the holding device and the fixing device of curved, and/or ovoid, and/or spherical shape.

According to one embodiment, it can be provided that the holding device has a spherical, substantially spherical or generally spherical outer shape.

According to one embodiment, the fixing device may have or comprise a female receiving shape, comprising a cylindrical portion or a spherical portion or a cone portion, for receiving the holding device.

According to one embodiment, the counter-shape comprises at least two distinct portions arranged to allow discrete fixing adjustment according to at least two distinct relative orientations, for example according to orthogonal directions, between the holding device and the fixing device. An indexing with in particular flats and/or notches can be provided to obtain a predetermined and discrete positioning (separate distinct positions).

According to one embodiment, the fixing device comprises at least one aperture, and/or the holding device fixed by the fixing device comprises at least one portion directly accessible from the outside, for example to receive a shock directly on the holding device. In other words, the fixing device is provided to leave at least part of the holding device directly accessible from the outside to be able to apply for example a shock during a shock test or vibrations during a vibration test directly on the holding device. The test is therefore reliable and representative, because the holding device (receiving and supporting the watch member) is directly engaged.

According to one embodiment, the testing device comprises an orientation adjustment device with orientation drive means arranged to move the holding device relative to the fixing device. Such orientation drive means make it possible to automatically adjust or assist an operator to quickly and reliably adjust the orientation between the holding device and the fixing device.

Alternatively or in combination, the orientation drive means make it possible to adjust the position of the fixing device on the testing machine. In other words, it can be provided to modify the relative position of the entire testing device relative to the testing machine.

According to one embodiment, the orientation drive means:
comprise a docking portion arranged to couple reversibly relative to the holding device and/or relative to the fixing device, and/or
comprise at least one roller for driving the holding device, and/or at least one track for driving the holding device, and/or at least one arm for driving the holding device. In general, the orientation drive means are provided to couple directly with the holding device and to move it relative to the fixing device, and/or directly on the fixing device and to move it relative to the machine.

According to one embodiment, the docking portion comprises a drive square (or any other form of rotational stop). According to one embodiment, the orientation drive means comprise locking means on the holding device, for example a ball plunger provided on the drive square.

According to one embodiment, the orientation drive means:
comprise a portion passing through the aperture, and/or
are arranged to come into contact with said at least one portion of the holding device directly accessible from the outside.

According to one embodiment, the fixing device comprises:
at least one cradle arranged to receive the holding device,
at least one clamping member movable between an opening position in which the holding device can be freely received or removed from the cradle, and a clamping position in which the holding device is clamped on the cradle, and said at least one clamping member is arranged to be able to occupy an adjustment position arranged between the clamping position and the opening position, and in which a relative orientation between the holding device and the fixing device can be adjusted. In other words, said at least one clamping member can occupy three different positions: opening position, clamping position and adjustment position. According to one embodiment, with said at least one clamping member in the adjustment position, the holding device cannot be removed from the testing device: the holding device can be moved to adjust a particular relative position, but it cannot be removed. Thus, in the adjustment position, the holding device cannot fall off or completely detach.

According to one embodiment, the cradle comprises said at least one counter-shape at least partially matching the holding device, and said at least one clamping member is provided to push and tighten the holding device in the counter-shape.

According to one embodiment, said at least one clamping member comprises at least:
a pivoting clamping lever, and/or
a sliding clamping jaw, and/or
a clamping screw.

According to one embodiment, the fixing device comprises means for reversible fixing on the testing machine.

According to one embodiment, the holding device comprises:
two half-shells arranged to be fixed together and arranged to contain the watch member, and/or
at least one measurement sensor such as an inclinometer, an accelerometer, an image sensor, a force sensor, and/or
an external casing with a contact surface for the fixing device that is substantially continuous, and/or curved, and/or ovoid, and/or spherical, and/or
a positioning device, such as a holding system, for positioning and/or holding the watch member on or in the holding device, for example by tightening or sandwiching, and/or
means for identifying a position of the watch member in the holding device.

As an example, a system can be provided that could allow the measurement of the linear accelerations with a triaxial sensor and the measurement of the angular accelerations by combining the first sensor with a linear accelerometer.

The sensor(s) can be provided as close as possible to the watch member, preferably at the center of gravity of the holding device, to ensure reliable acceleration measurements.

These acceleration measurements can be performed on a dummy watch member, for example a blank of the same shape and weight as the watch movement, in which an accelerometer has been fixed. Once the measurements have been performed for a testing machine and a given orientation, the same test can be performed on the watch member based on the assumption that the forces and accelerations will be the same as those measured on the dummy element. It is then possible to guarantee that tests are performed in multiple orientations, and in order to further improve the accuracy of the measurements, calibration phases can be provided both in the relative orientation and in the measurement of the physical parameters. Such a calibration makes it possible to take into account the specificities of the testing device, of the relative orientation, or of the test itself.

At least one vision system can be provided to observe the impact of the shocks on the watch and the movement.

All of the information collected can be sent to a central unit, which can be integrated into the testing machine.

The holding device can include a wired connection or a wireless connection to transmit the measured information to the central unit (such as a computer).

Preferably, the testing device also comprises at least one identification means, such as a bar code or an RFID chip.

According to one embodiment, the components of the testing device (holding device and fixing device) which are in contact with other components (for clamping, for applying shocks, etc.) can be made from:
a wear-resistant steel with good surface hardness such as DIN 1.2510, and/or
an aluminium treated by anodisation or oxidation (e.g. by micro-arc) to transform and harden its surface, and/or
a polymer (Polyoxymethylene (POM)) and/or an elastomer (polyurethane (PUR)) and/or plastic and/or titanium and/or any other metal material.

It should be noted that these components can be made of different materials (bi-material or multi-material). The choice of the appropriate material must take into account the mechanical characteristics of the material and its weight, which must be as low as possible.

According to one embodiment, the testing device comprises the watch member, formed by a watch movement, or a watch head, or a wristwatch.

According to one embodiment, the watch member is held on or in the holding device. The watch member can be contained in the holding device during the tests, but it can also be provided that the watch member is accessible from the outside when the watch member is attached to the holding device. In other words, the watch member is not necessarily contained or enclosed in the holding device during the tests.

A second aspect of the invention relates to a testing machine comprising a testing device according to the first aspect for performing a shock test, and/or a linear acceleration test, and/or a vibration test, and/or an angular acceleration test.

According to one embodiment, the testing machine comprises:
a chassis,
a test arm, movable relative to the chassis,
an anvil (or a target or an impact plate or a base block), fixed relative to the chassis, and the testing device is supported by a free end of the test arm, the test arm being arranged to project the testing device, and particularly the holding device against the anvil (or a target or an impact plate or a base block).

According to one embodiment, the testing machine can be provided to perform shock tests on watch movements and watches according to different standards such as NIHS 91-10 of April 2016, NIHS 91-20 of April 2022, NIHS 91-30 of August 2021 or NIHS 93-20 of August 2021.

Thus, according to the different implementations below, it is possible to optimize the test rates and ensure reproducibility on each movement, the solution offers the possibilities below:
Being able to use the same support, for different movements or watch head, for different tests on different testing equipment;
Quickly and simply identifying the position of a reference plane of the watch member and orienting it according to different spatial orientations (automatically or not) in an accurate and reproducible manner;
Being able to perform new, unprecedented tests using an infinite spectrum of orientations of the movement to be tested.

### DESCRIPTION OF THE FIGURES

Other characteristics and advantages of the present invention will become more clearly apparent upon reading the following detailed description of embodiment(s) of the invention given as non-limiting examples and illustrated by the appended drawings, in which:

FIG. 1 represents a simplified diagram of a testing machine provided to apply a shock to a watch member and comprising a test arm in an initial position, supporting a testing device according to the invention comprising a holding device enclosing the watch member and a fixing device arranged to fix the holding device to the test arm of the testing machine;

FIG. 2 represents the testing machine of FIG. 1 with the test arm in a final position, the holding device having been projected onto an anvil (or a target or an impact plate) of the testing machine;

FIG. 3a represents part of the testing machine of FIG. 1 with the fixing device having partially released the holding device to be able to adjust a relative position of the holding device relative to the test arm;

FIG. 3b represents part of the testing machine of FIG. 1 with the fixing device having completely released the holding device to be able to remove it from the testing machine;

FIG. 4 represents a sectional view of one exemplary embodiment of part of the holding device of FIG. 1;

FIG. 5 represents a perspective view of one exemplary embodiment of a system for holding the watch member in the holding device;

FIG. 6 represents a sectional view of part of the holding device of FIG. 4 receiving the holding system and the watch member of FIG. 5;

FIG. 7 represents in detail one exemplary embodiment of a fixing device receiving the holding device of FIG. 4 or 6;

FIG. 8 represents orientation drive means that can be used to change a relative orientation between the holding device and the fixing device, for example when the fixing device has partially released the holding device.

### DETAILED DESCRIPTION OF EMBODIMENTS

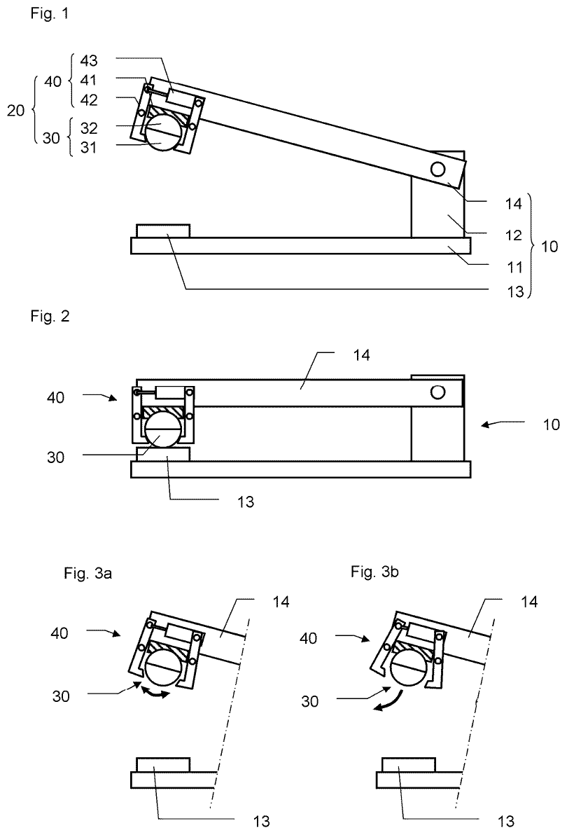

FIG. 1 represents a simplified diagram of a testing machine 10 provided to apply a shock to a watch member and comprising a test arm 14 in an initial position, supporting a testing device 20 according to the invention comprising a holding device 30 enclosing the watch member and a fixing device 40 arranged to fix the holding device 30 on the test arm 14 of the testing machine 10.

In detail, and according to the simplified example represented, the testing machine 10 comprises:
a base table 11,
a bracket 12 fixed on the base table 11,
an anvil 13 also fixed on the base table 11,
a test arm 14 mounted on the bracket 12 and articulated according to a pivot connection according to this particular example.

The testing device 20 comprises in particular a holding device 30 which embeds the watch member and the fixing device 40 which is provided to reversibly fix or attach the holding device 30 to the testing machine 10 and particularly to the test arm 14.

The holding device 30 comprises two half-shells 31 and 32 assembled together to have a spherical or substantially spherical or generally spherical shape. The structure will be better detailed below with reference to FIGS. 4 to 6.

The fixing device 40 comprises a counter-shape forming a cradle 41 which receives the holding device 30, two pivoting clamping arms 42 and a clamping jack 43 arranged between the two clamping arms 42 to exert a reversible clamping force on the holding device 30. In FIG. 1, the two clamping arms 42 are in contact with the holding device 30 and hold it firmly under the action of the clamping jack 43.

To apply a shock to the watch member embedded in the holding device, the testing machine 10 can of course comprise control and/or motorization means for pivoting the test arm 14. In FIG. 1, the test arm 14 is in an initial test position and holds the holding device (via the fixing device 40) facing the anvil 13 carried by the base table 11. In FIG. 2, the test arm 14 has passed into a final test position, the holding device 30 having been projected against the anvil 13 to undergo a shock. Depending on the pivoting speeds of the test arm 14 and/or on the masses of the various components, it is possible to impose shocks with decelerations of the order of a few g to several hundreds, thousands or tens of thousands of g.

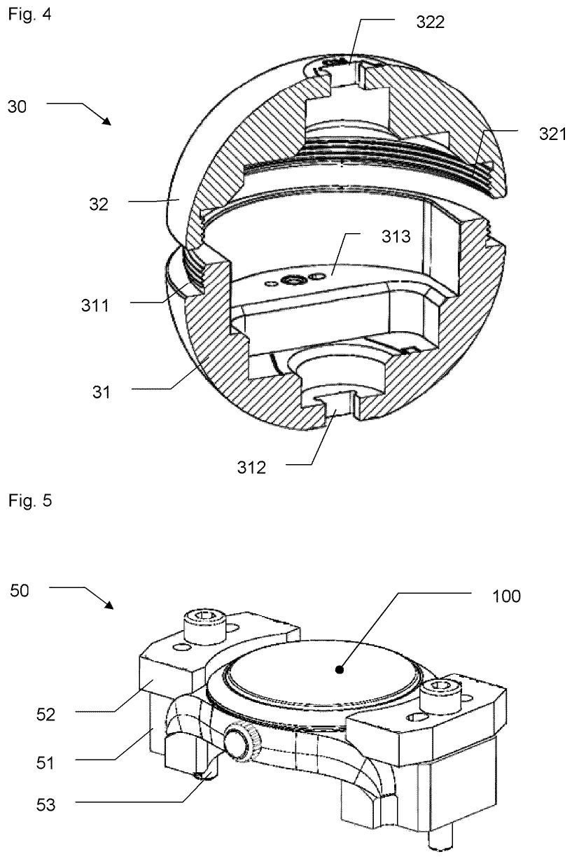

In FIG. 1, the two clamping arms 42 are in a clamping position, in which they firmly fix and hold the holding device 30 on the cradle 41. In FIG. 3a, after actuation of the clamping jack 43, the two clamping arms 42 are in an adjustment position, in which they leave the holding device 30 free to be moved and repositioned in the cradle 41. However, with the two clamping arms 42 in the adjustment position, the holding device 30 cannot be completely removed from the fixing device 40. In FIG. 3b, after actuation of the clamping jack 43, the two clamping arms 42 are in an opening position, in which they leave the holding device 30 completely free to be removed from the cradle 41 and from the testing machine 10.

It can be noted that the cradle 41 has a counter-shape, with the spherical (or substantially spherical) shape of the holding device, so that in the opening position or in the adjustment position, an infinite number of relative positions can be imposed between the holding device 30 and the fixing device 40 and therefore between the holding device 30 and the testing machine 10.

FIG. 4 represents a sectional view of one exemplary embodiment of part of the holding device 30 of FIG. 1. As indicated, the holding device 30 comprises two half-shells 31 and 32 assembled together for example by screwing. In detail, it is possible to provide a first half-shell 31 which includes a thread 311 and a second half-shell 32 which comprises a tapping 321 provided to engage with the thread 311. The first half-shell 31 and the second half-shell 32 are each hollowed out to receive a holding system which supports the watch member to be tested. Particularly, a fixing interface 313 (here an inner fixing plane with tappings and blind location holes) can be provided in the recess of the first half-shell 31. A first drive square 312 (or any other form of rotational stop) which opens out onto the outer surface of the first half-shell 31 and a second drive square 322 (or any other form of rotational stop) which opens out onto the second half-shell 32 can also be provided. It can be noted that the first drive square 312 is substantially coaxial with the second drive square 322, and/or of a direction substantially normal to the inner fixing plane of the fixing interface 313. The first drive square 312 and the second drive square 322 can be used to assemble, tighten, loosen, manipulate, position the first half-shell 31 and/or the second half-shell 32.

FIG. 5 represents a perspective view of one exemplary embodiment of a system 50 for holding the watch member 100 in the holding device 30. In this particular example, the watch member 100 is formed by a watch case containing a watch movement. The holding system 50 comprises two flanges that can clamp the horns and the watch case and that each comprise a base plate 51 and a flange head 52, held together by at least one fixing screw 53. A single base plate which receives the two flange heads 52 can be provided.

As a part of a testing machine 10 for imposing shocks, a particular material can be provided for the half-shells 31 and 32. Stainless steels, hardened steels or steels treated on the surface can be provided to have sufficient hardness which guarantees durability and an absence of deformations. Surface-hardened aluminum or polymer materials can also be provided. In other words, a material that allows transmitting the greatest possible energy to the movement in a repeatable manner can be provided. To properly take into account the influence of the materials, of the geometry and of the testing apparatus, a calibration of the testing device can be provided with sensors to properly determine the accelerations undergone by the part to be tested, in each of the relative orientations to be tested.

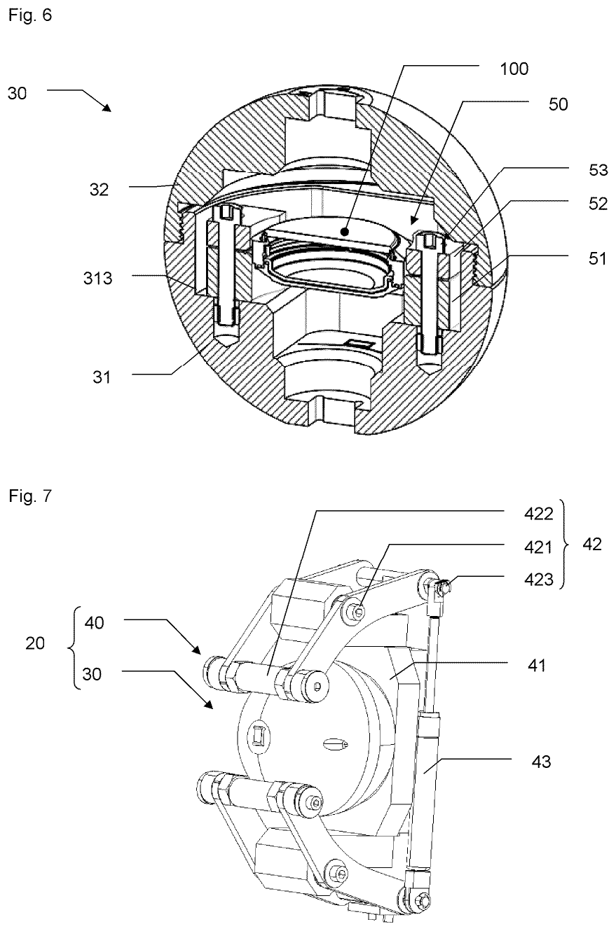

FIG. 6 represents a sectional view of part of the holding device 30 of FIG. 4 receiving the holding system 50 and the watch member 100 of FIG. 5. As in FIG. 5, the watch member 100 is pinched or clamped between the base plate 51 and the flange head 52 of the two fixing flanges, and as shown in FIG. 6, the flanges of the holding system 50 are each fixed to the fixing interface 313 of the first half-shell 31 by the fixing screws 53. Finally, in FIG. 6, the holding device 30 is closed on the watch member 100, that is to say the first half-shell 31 is screwed into the second half-shell 32, to form a sphere.

It can be noted in FIG. 6, above or below the watch member 100, the presence of a recess that can be used to place a measurement sensor (shocks, vibrations, vision sensor, etc.) during the tests. Such a sensor can be clamped or fixed by screws for example, and it can be provided to calibrate it to ensure good measurement accuracy. It can also be provided to install instead of the watch member 10 a dummy watch member that would contain the aforementioned sensors.

FIG. 7 represents the fixing device 40 receiving the holding device 30. It can be noted that each of the two clamping arms 42 is articulated in rotation about a pivot axis 421, so that a contact interface 422 (in this example, a cylindrical shaft) can bear on the holding device 30 and that the clamping jack 43 can act on a control axis 423 to simultaneously move the two clamping arms 42. In FIG. 7, the two clamping arms 42 are pushed back at the axes 423 against the holding device 30 by the clamping jack 43, which presses the holding device 30 against the cradle 41, in the counter-shape of the latter. Thus, the holding device 30 is firmly pressed against the cradle 41 and if a shock is applied to the holding device 30, the relative position of the holding device 30 relative to the cradle 41 remains unchanged.

As indicated in the explanations relating to FIG. 3a, it is possible to loosen the grip of the clamping arms 42 on the holding device 30 to allow relative movement between the holding device 30 and the fixing device, particularly relative to the cradle 41.

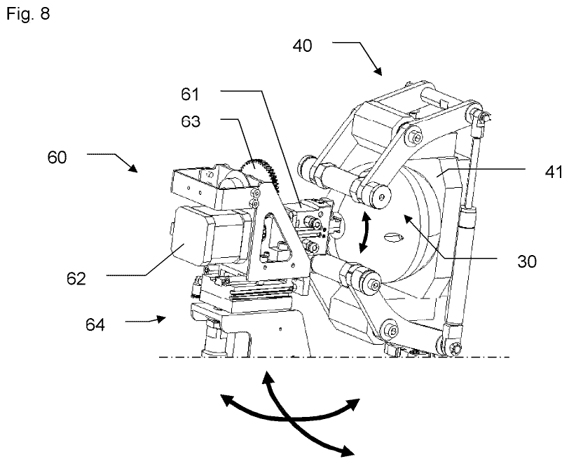

FIG. 8 represents an example of orientation drive means 60 that can be used to change a relative orientation between the holding device 30 and the cradle 41, for example when the fixing device has partially released the holding device 30 as in FIG. 3a.

The orientation drive means 60 of FIG. 8 comprise in particular:
an alignment clamp 61, provided to couple with the holding device 30 (with one of the first drive square 312 or of the second drive square 322),
a control jack 62, provided to couple and uncouple the alignment clamp 61 to/from the holding device 30,
a rotating actuator 63, here a rotary motor with a gearing to drive the alignment clamp 61 in rotation, and also the holding device 30 when the alignment clamp 61 is coupled thereto,
displacement means 64, provided to approach and insert the alignment clamp 61 into one of the first drive square 312 or of the second drive square 322. As shown by the arrows at the bottom of FIG. 8, elements can be provided allowing the orientation drive means 60 to pivot:
about a substantially vertical axis in FIG. 8 and passing substantially through the center of gravity of the holding device 30, and/or
about a substantially horizontal axis in FIG. 8 and passing substantially through the center of gravity of the holding device 30.

Thus, it can be provided to automatically move in a controlled manner the holding device 30 relative to the cradle 41. Particularly, the rotating actuator 63 may comprise a stepper motor to impose a predetermined and accurate rotation on the holding device 30 relative to the cradle 41. It can also be provided to calibrate the orientation drive means 60 to ensure good accuracy and/or good reproducibility of the relative positioning imposed by the rotation drive means 60.

The testing machine 10 may therefore receive the holding device 30 in a particular position to perform a dynamic test (such as a choc test according to the given example).

As indicated above and as shown in particular in FIGS. 1, 2 and 6, the relative position between the holding device 30 and the fixing device 40 imposes a relative position between the watch member 100 and the testing machine 10, and particularly with the anvil (or target or impact plate) 13 in the example of a shock machine. It may be noted that at the end of tests performed with a first relative position between the holding device 30 and the testing machine 10, it is easy to change this relative position or orientation. Indeed, it is sufficient to pass the clamping arms 42 into the adjustment position to unclamp the holding device 30 and modify its relative position relative to the cradle 41 before passing the clamping arms 42 back into the clamping position in order to re-clamp the holding device 30 in a new relative position with the testing machine 10.

The counter-shape of the cradle 41 makes it possible to provide an infinite number of relative positions between the holding device 30 and the testing machine 10. It is possible to provide tests in 6 orthogonal directions of a Cartesian coordinate system: +X; +Y; +Z; −X; −Y; −Z, and tests can easily be performed according to positions or orientations intermediate to these main axes. To ensure the accuracy of the relative position or orientation, it can be provided to use the orientation drive means 60, and/or it is possible to provide a marking or a particular notching on the holding device 30 to give a positioning reference or marker to an operator or to an automaton of the testing machine 10.

### INDUSTRIAL APPLICATION

A testing device according to the present invention, and its manufacture, are capable of industrial application.

It will be understood that various modifications and/or improvements obvious to those skilled in the art can be made to the different embodiments of the invention described in the present description without departing from the scope of the invention.

Particularly, it can be noted that the first male half-shell 31 and the second half-shell 32 of FIGS. 4 and 6 are assembled together by screwing, but other types of assembly mode can be provided (by screw, by elastic interlocking, etc.).

The external shape of the holding device 30 is spherical, but other shapes can be provided which allow relative repositioning with the fixing device. For example, a smooth counter-shape can be provided so as to be able to offer an infinite number of relative positions, but counter-shapes with pre-positioning (splines, notches, etc.) can also be provided. For example, grooves can be included on the external surface of the holding device. For example, these grooves can also indicate the position of the watch member present in the holding device, and/or present a means for identifying and/or presenting an indexing means.

In the example given, the cradle 41 comprises a spherical counter-shape, but a cylindrical hole with a chamfer or a cone portion can be provided to receive the holding device 30.

The orientation drive means 60 can comprise rollers or drive rollers instead of the alignment clamp 61. Alternatively, a five-axis robot with a gripping clamp which can reposition the holding device 30 in the cradle 41 can be provided.

The holding device 30 may vary depending on the model and the size of the watch member 100 to be tested.

Similarly, several types of fixing fittings 50 can be provided depending on the watch member 100 to be tested. It can be provided to fix the watch member 100 to be tested by bearing on the horns, or alternatively on the bezel if it is not rotating bezel. It can be provided to test a bare movement, and in this case, its fixing in the holding device 30 would then be preferably carried out by compression directly on a plate. It can also be provided to hold the watch member 100 to be tested by compression or sandwiching between the components of the holding device 30. With regard to the test of a wristwatch, the holding system can be formed by a cylinder with an ellipsoidal section, allowing a hold similar to that of a human wrist.

It can be noted that the drive squares 312 or 322 can be replaced by any other shape that allows rotational indexing. If a sufficiently powerful clamp is provided, a cylindrical hole with a circular section can even be proposed.

1. A device for testing a watch member, comprising at least:
a holding device, arranged to receive and hold in place the watch member,
a fixing device, arranged to fix the holding device on a testing machine, characterized in that one of the holding device and of the fixing device comprises a counter-shape at least partially matching the other of the holding device and of the fixing device, and in that the counter-shape is arranged to allow an adjustment to fix the holding device according to at least seven distinct relative orientations between the holding device and the fixing device.

2. The testing device according to claim 1, wherein the counter-shape comprises at least one continuous portion of contact between the holding device and the fixing device and arranged to allow a continuous variation of the fixing adjustment between at least two distinct and orthogonal relative orientations between the holding device and the fixing device.

3. The testing device according to claim 2, wherein said at least one continuous portion comprises a continuous surface of contact between the holding device and the fixing device of curved, and/or ovoid, and/or spherical shape.

4. The testing device according to claim 1, wherein the counter-shape comprises at least two distinct portions arranged to allow discrete fixing adjustment according to at least two distinct relative orientations, for example according to orthogonal directions, between the holding device and the fixing device.

5. The testing device according to claim 1, wherein the fixing device comprises at least one aperture, and/or wherein the holding device fixed by the fixing device comprises at least one portion directly accessible from the outside, for example to receive a shock directly on the holding device.

6. The testing device according to claim 1, comprising an orientation adjustment device with orientation drive means arranged to move the holding device relative to the fixing device.

7. The testing device according to claim 6, wherein the orientation drive means:
comprise a docking portion arranged to couple reversibly relative to the holding device, and/or
comprise at least one roller for driving the holding device, and/or at least one track for driving the holding device, and/or at least one arm for driving the holding device.

8. The testing device according to claim 6, wherein the orientation drive means:
comprise a portion passing through the aperture; and/or
are arranged to come into contact with said at least one portion of the holding device directly accessible from the outside.

9. The testing device of claim 1, wherein the fixing device comprises:
at least one cradle arranged to receive the holding device,
at least one clamping member movable between an opening position in which the holding device can be freely received or removed from the cradle, and a clamping position in which the holding device is clamped on the cradle,
and wherein said at least one clamping member is arranged to be able to occupy an adjustment position arranged between the clamping position and the opening position, and in which a relative orientation between the holding device and the fixing device can be adjusted.

10. The testing device according to claim 9, wherein the cradle comprises said at least one counter-shape at least partially matching the holding device, and wherein said at least one clamping member is provided to push and tighten the holding device in the counter-shape.

11. The testing device according to claim 9, wherein said at least one clamping member comprises at least:
a pivoting clamping lever, and/or
a sliding clamping jaw, and/or
a clamping screw.

12. The testing device according to claim 1, wherein the fixing device comprises means for reversible fixing on the testing machine.

13. The testing device according to claim 1, wherein the holding device comprises:
two half-shells arranged to be fixed together and arranged to contain the watch member, and/or
at least one measurement sensor such as an inclinometer, an accelerometer, an image sensor, a force sensor, and/or
an external casing with a contact surface for the fixing device that is substantially continuous, and/or curved, and/or ovoid, and/or spherical, and/or
a positioning device for positioning and/or holding the watch member on the holding device, for example by tightening or sandwiching
means for identifying a position of the watch member in the holding device.

14. The testing device according to claim 1, comprising the watch member, formed by a watch movement, or a watch head, or a wristwatch.

15. A testing machine comprising a testing device according to claim 1 for performing a shock test, and/or a linear acceleration test, and/or a vibration test, and/or an angular acceleration test.
